(19) United States
(12) Patent Application Publication
(10) Pub. No.: US 2004/0118155 A1
(43) Pub. Date: Jun. 24, 2004

(54) Method of making ultra-dry, Cl-free and F-doped high purity fused silica

(76) Inventors: John T. Brown, Corning, NY (US); Stephen C. Currie, Corning, NY (US); Susan L. Schiefelbein, Ithaca, NY (US); Michael H. Wasilewski, Corning, NY (US); HuaiLiang Wei, Allen, TX (US)

Correspondence Address: CORNING INCORPORATED, SP-TI-3-1, CORNING, NY, 14831

(21) Appl. No.: 10/326,200

(22) Filed: Dec. 20, 2002

(51) Int. Cl. C03B 32/00

(52) U.S. Cl. 65/17.2; 65/17.4; 65/30.1

(57) ABSTRACT

The present invention is directed to a method of making an ultra dry high purity, Cl-free, F doped fused silica glass. Silica powder or soot preforms are used to form a glass under conditions to provide a desired level of F doping while reducing the Cl and ⁻OH concentrations to trace levels. The method includes providing a glass precursor in the from of a silica powder or soot preform. The powder is heated in a furnace. The powder is exposed to a F-species at a predetermined temperature and time sufficient to melt the powder and form a high purity fused silica glass in the bottom of said furnace.

### FIELD OF THE INVENTION

The invention relates in general to a method-of making a high purity silica and more specifically to a method for making ultra-dry, chlorine free, fluorine doped high purity fused silica (SiO₂).

### BACKGROUND OF THE INVENTION

There has been a continuing need for a source of high purity fused silica (HPFS) for use in the manufacture of photomasks in 157-nm photolithography in the semiconductor industry. It is believed that silica doped with F will enhance UV transmission of HPFS and that —OH and chlorine in the silica network would significantly contribute to UV adsorption for 157 nm applications. HPFS is typically made using SiCl4 or octamethylcyclotetrasiloxane (OMCTS) by a direct laydown method, in which SiCl4 or OMCTS vapor is combusted with oxygen and a methane/oxygen flame to make silica glass. This process inherently incorporates OH and Cl (if SiCl₄ is used, only OH if OMCTS is used) into the resulting glass in a typical concentration of several hundred ppm of OH and tens to hundreds ppm of Cl. It can therefore be seen that new processes or new precursors are needed in order to make ultra-dry, Cl-free glasses in order to meet the demands of the semiconductor industry.

The present invention is directed to addressing the problems of the prior art described above and relates to a novel process for making a F doped, Cl-free, high purity fused silica having ultra-low —OH content.

### SUMMARY OF THE INVENTION

It is therefore an object of the present invention to provide a method for making a C1⁻ free high purity fused silica.

It is a further object of the present invention to provide a method for making a F doped high purity fused silica.

It is another object of the present invention to utilize soot preforms in the manufacture of high purity fused silica.

It is a further object of the present invention to provide a method of forming high purity fused silica from a soot stream which forms a glass directly at a furnace burner.

It is another object of the present invention to provide for a method of making a high purity fused silica which is chlorine free and contains ultra low ▭OH content.

The present invention utilizes powders or soot preforms of silica which have been made by flame hydrolysis, sol gel or other processes using OMCTS or other Cl-free precursors such as siloxanes.

In one embodiment the silica powder or soot preforms are placed in an inert crucible which is positioned inside a furnace such as one used in high purity fused silica (HPFS) production. The bottom of the crucible is preferably porous under which a vacuum is applied to keep the powder in place and remove gas entrapped in the powder during processing. A burner is mounted on top of the furnace to provide heat to make the glass. A fluorine containing species is delivered to the crucible with the furnace temperature being kept at a level to activate the reaction of the F-species with water and OH in the powder. Vapor of HF is exhausted out of the furnace. The furnace temperature is increased with a continuing flow of F species to melt the powder into a clear glass.

In a second embodiment of the present invention, the SiO2 powder is delivered to the burner as a dry suspension in oxygen or an inert gas such as nitrogen. The powder is contained in an enclosed chamber having a screen at the bottom. Nitrogen gas is flowed up from the bottom through the screen and forms a soot stream which passes through a fume line into the burner which melts the powder and forms the glass which is deposited into a cup or crucible positioned below the burner.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a schematic view of a burner-furnace design suitable for use in the present invention;

FIG. 2 is a schematic view of a powder burner delivery design suitable for use in the present invention;

FIG. 3 is a side sectional view of the burner-furnace design utilizing the powder delivery system shown in FIG. 2; and

FIG. 4 is a schematic side cut away view of a burner design suitable for use in the present invention.

### DETAILED DESCRIPTION OF THE INVENTION

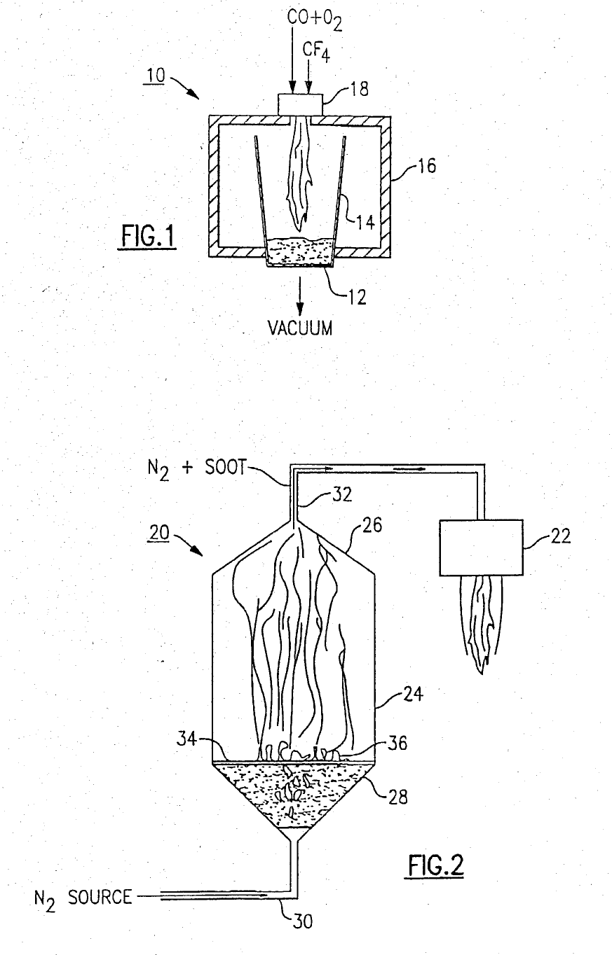

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the burner-furnace design suitable for use in the present invention is shown in FIG. 1, and is designated generally throughout by reference numeral 10.

In attempts to produce dry, Cl-free, fluorinated silica glass for 157 nm photomask plates, it has been demonstrated that SiO₂ glass can be produced using CO fuel and either SiCl₄ or OMCTS Silica precursors using a standard vapor deposition or direct laydown process. These glasses, however, do not meet all of the requirements for the 157 nm photomask application. While SiCl₄ has the advantage of being H-free, and can be used to produce dry (<1 ppm OH) glass, the presence of so much Cl (four Cl for each Si) results in Cl-contaminated (>100 ppm Cl) glass. On the other hand, while OMCTS has the advantage of being Cl-free, and can be used to produce Cl-free (<1 ppm) glass, the presence of so much H (six H for every Si) results in wet (>400 ppm) glass. The process of the present invention described above overcomes the current problems of the prior art.

The present invention may be best understood with reference to the accompanying drawings. Apparatus suitable for making high purity ultra-dry, Cl-free and F-doped fused silica is shown in FIG. 1 which illustrates a burner-furnace design 10. Powders or soot preforms of silica 12 made by flame hydrolysis, sol-gel or other processes using OMCTS or other Cl-free Silica precursors such as siloxanes are placed in a supporting inert cup or crucible 14 and placed inside a furnace 16 such as one used in conventional fused silica production. The bottom of the cup is preferably porous and permeable (not shown), and is placed under a vacuum which functions to keep powder in place and remove gas entrapped in the silica powders or soot preforms during the process. A burner 18 is mounted on the top of the furnace for delivery of heat needed to make the glass. The burner can be a CO/O₂ torch or a thermal plasma (argon) torch which does not contain any hydrogen atoms.

F-containing gas species such as CF₄, C₂F₆ and SF₆ is delivered via burner 18 to the cup containing silica powders or soot preforms (precursor). The furnace temperature is kept at the level that is sufficient to activate the reaction of F-species with water and OH in the powders or soot preforms, but not cause significant densification of the powders or preforms. The temperature can be in the range from about 500 to 1000° C. In this stage, the following reaction occurs,

Fluorine radicals+H₂O (or—OH) 6 HF 8

Vapors of HF are exhausted out of the furnace. The drying time is typically 30 minutes to several hours dependent of the sizes of powders or soot preforms.

After sufficient drying, the furnace temperature is increased gradually to about 1800° C. with continuing flow of F-species to melt the powders or soot preforms contained in the cup in to clear glass.

The above process, starting with 400 grams of soot (0.5 g/cc density), will yield 400 grams of glass (2.2 g/cc density), assuming that all of the soot is maintained in the crucible during the drying or heating cycle(s). After the soot drying phase is complete (30-180 minutes at 500-1000 deg C.) the furnace temperature is ramped to 1800-1850 deg C. and held for a minimum of 2 hours to vitrify the soot. The temperature could be lower than 1800 deg C. when using F, because F decreases the viscosity and allows sintering at lower temperatures.

The silica produced using the method of the present invention includes fluorine (F) in a range between 100 ppm-5 wt %. The silica also includes the following maximum threshold levels of key elements:

| | | |
|---|---|---|
| Cl | <5 | ppm |
| OH | <1 | ppm |
| Fe | <0.05 | ppm |
| Zr | <0.05 | ppm |
| Al | <0.5 | ppm |
| Na | <0.5 | ppm. |

The above described embodiment of the invention uses SiO₂ powder as the Silica precursor with CO as fuel. The use of such a Cl- and H-free Silica precursor in a CO burner allows for the production of dry, Cl-free F doped high purity fused silica glass suitable for use in 157 mn photomask applications. Of course, the fluorine may be introduced by delivering the F-containing gas species via burner 18, or by some other method.

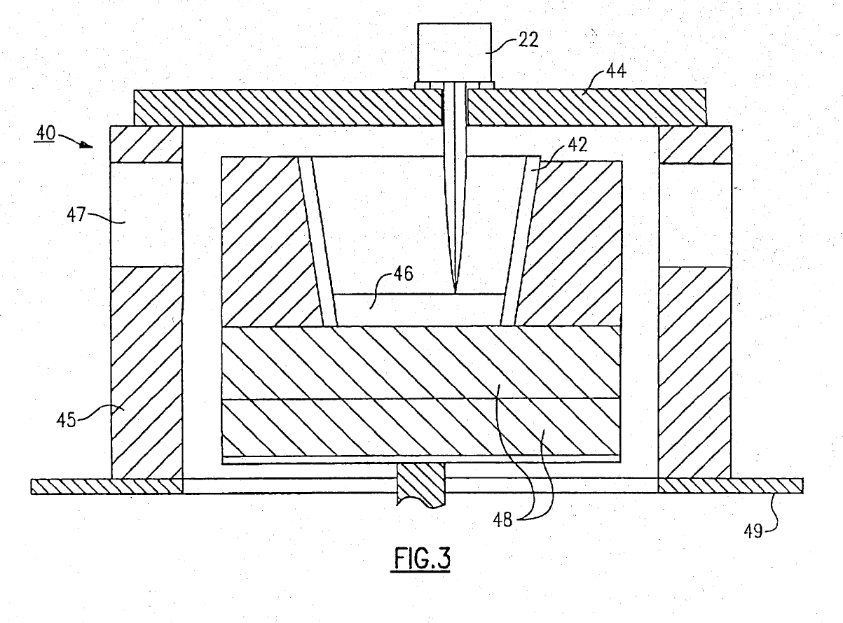

A second embodiment of the present invention is described below and is illustrated by delivery system 20 in FIG. 2 in combination with a furnace assembly 40 illustrated in FIG. 3.

In a suitable powder delivery system as shown in FIG. 2, both ends of a 2000 ml Nalgene™ container 24 were cut off and funnels 26 and 28 were attached to both ends. A ¼″ line 30 is attached to the bottom funnel 28 for an inlet for a source of N₂. Another ¼″ line 32 is attached to top funnel 26 to provide an fume outlet. A screen 34 is installed on top of the bottom funnel to hold a source of silica powder. Before the top funnel 26 is attached, about 100 grams of silica soot 36 is placed on top of the screen. A fume outlet line 32 is then connected to D burner 22 and 5-101 pm of N₂ is flowed through the bottom line which “bubbles” up through the soot, and due to the small particle size, some of the soot is suspended in the N₂ gas forming a soot stream which is then passed through the fume line and out the fume tube of burner 22. Reference is made to Co-pending U.S. patent application Ser. No. 09/101,403, which is incorporated herein by reference as though fully set forth in its entirety, for a more detailed explanation of a D-burner. These conditions establish a uniform flow for the soot stream.

Referring to FIG. 3, burner 22 receives inputs of CO, O₂ and SiO₂ soot powder delivered from the delivery system described above in FIG. 2 as a “dry suspension” in O₂ or an inert gas (e.g. N₂, He, Ar, etc.). CF₄ (or any other F-dopant) may also be added to the input if fluorinated SiO₂ is desired. It has been demonstrated that SiO₂ powder can be delivered to a burner by flowing a carrier gas through a container of powder.

Assuming a capture efficiency of about 30%, passing 3333 grams of soot through the burner will generate 1000 grams of high purity fused silica glass. Typically 6 grams per minute of SiO₂ powder is delivered to the burner. About 2 hours is allowed to pre-heat the furnace 40, and 9.3 hours of laydown time (3333 grams @ 6 grams/min.), for a total run time of about 11.3 hours.

As the SiO₂ powder contained in the nitrogen soot stream passes through the burner and enters the flame envelope, it is heated to the point where it will vitrify immediately as it is deposited in a pre-heated cup 42 supported on a turntable base 48.

As shown in the drawings, the burner is mounted on the furnace crown 44. The furnace further includes a ring wall 45, vent 47 and furnace frame 49. The burner is lit, and the furnace is pre-heated (by conventional means not shown) to at least 1625 deg C. (crown temperature) before the N2/SiO₂ soot stream is turned on. The final target temperature for the crown is 1670 deg C., which equates to a temperature of 1850-1900 deg C. in the bottom of cup 42. At these temperatures, the SiO₂ powder will vitrify immediately as it is deposited in the cup. If the soot is fluorinated, the lower temperature limit may be much lower. For example, if the soot is fluorinated, the temperature range in the bottom of cup 42 may be in the range between 1500-1900 deg C. In one embodiment, soot deposition continues for several hours in order to form a glass boule 46 that is 2-3 inches thick and 5-7 inches in diameter. The soot delivery is then stopped, and the burner is shut down, allowing the glass to cool and solidify. Those of ordinary skill in the art will recognize that glass boules having other dimensions may be formed using the process of the present invention.

The silica produced using the method of the present invention includes fluorine (F) in a range between 100 ppm-5 wt %. The silica also includes the following maximum threshold levels of key elements:

| | | |
|---|---|---|
| Cl | <5 | ppm |
| OH | <1 | ppm |
| Fe | <0.05 | ppm |
| Zr | <0.05 | ppm |
| Al | <0.5 | ppm |
| Na | <0.5 | ppm. |

While SiO₂ powder may not be the only Cl- and H-free, Silica precursor suitable for this application it has one significant advantage: chemical inertness. It is, therefore, quite easy and safe to handle.

A suitable burner design for this application should provide for the following:

(i) deliver approximately the same heat as a D burner using methane,

(ii) have approximately a parabolic velocity profile similar to that of a D burner using methane, and

(iii) be installed in the furnace so as to exclude moist ambient air.

Reference is made to U.S. patent application Ser. No. 09/101,403, which is incorporated herein by reference as though fully set forth in its entirety, for a more detailed explanation of the D burner.

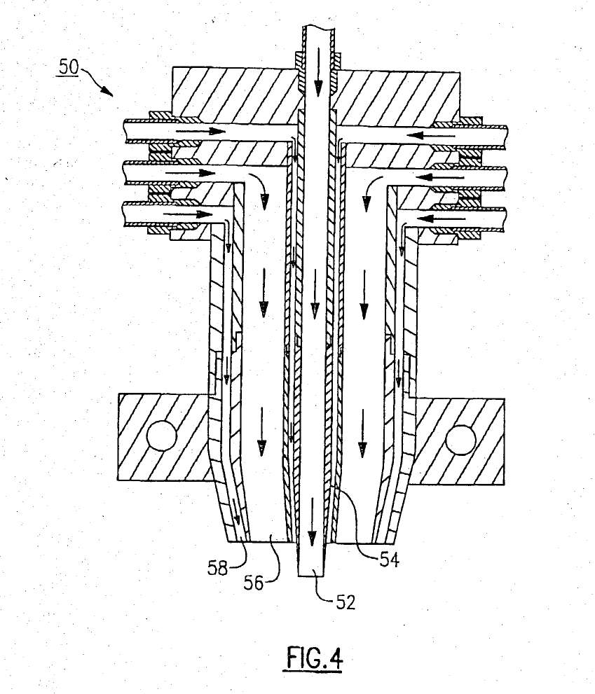

FIG. 4 illustrates the key components of a burner design 50 shown in cutaway view which is suitable for use in the above described embodiment. This design is known as a concentric tube-in-tube burner. The arrows in the drawing indicate the flow direction.

The center, or fume tube 52, in the burner functions to transport a fume stream consisting of the SiO₂ powder suspended in the carrier gas (i.e., oxygen or nitrogen) which passes through this tube. Dopants such as fluorine can also be delivered through this tube. An inner shield 54 provides a stream to keep the SiO₂ fume separated from the flame near the burner face. Oxygen is typically used as the inner shield gas. A pre-mix tube 56 carries the combination of fuel (carbon monoxide in this case) and oxygen which create the flame when combusted. The gases for this tube have already been mixed in a specific ratio before they reach the burner. An outer shield tube 58 transports an outer shield gas, usually oxygen which functions to constrain and shape the flame. In operation, the SiO₂ powder passes through the burner and enters the flame envelope, it will become super heated to the point where the powder will turn directly to glass as it is deposited in the bottom the cup inside the furnace.

The greatest challenge in using SiO₂ powder may be achieving the necessary purity in the deposited glass/soot. The absence of a chemical reaction to form the SiO₂ (it is delivered in its final form) combined with the lack of chlorine in such a process makes it difficult to remove impurities (specifically metallic impurities) from the powder. As a result, in order to attain the required purity in the final glass, the starting materials must be of a very high purity. However, although commercially available silica powders are not pure enough for the proposed application, the powders can be purified in a preliminary step. For example, the silica powder may be purified in a fluidized bed with flowing Cl₂ and/or CO at ˜1000 deg C. Another possible option is to use very high purity powders by CVD or by other means.

In order to obtain the required purity in the final glass, the starting materials must be of a very high purity. For Photomask glass to achieve 99% transmission at 157 nm, it requires <0.05 ppm (weight) of Fe and Zr, and <0.5 ppm (weight) of Al and Na. For the proposed application, if the initial impurities are not low enough the powders can be purified and dried in a preliminary step. For example, the silica powder may be treated in a fluidized bed with flowing Cl₂ and/or CO at ˜1000 deg C. If Cl₂ is used, an additional process step would be needed to purge the Cl₂ from the powder after the purification/drying step. This would involve a second treatment with a dry gas, such as helium.

Powder properties such as size, size distribution, morphology, and impurity content will influence the physical and optical quality of the final glass product.

There are many possible configurations for the powder delivery system. As long as the output is a fluidized stream of powder, the details of the physical system are not critical.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

We claim:

1. A method of forming an ultra dry, Cl-free, F doped fused silica glass which comprises the steps of:
providing a glass precursor in the from of a silica powder or soot preform; and
heating said powder in a furnace, while exposing said powder to a F-species at a temperature and for a time sufficient to melt said powder and form a high purity fused silica glass in the bottom of said furnace.

2. The method of claim 1, wherein the ultra dry, Cl-free, F doped fused silica glass includes fluorine (F) in the range between 100 ppm-5 wt %.

3. The method of claim 1, wherein the ultra dry, Cl-free, F doped fused silica glass includes maximum threshold levels for the following key elements:

| | | |
|---|---|---|
| Cl | <5 | ppm |
| OH | <1 | ppm |
| Fe | <0.05 | ppm |
| Zr | <0.05 | ppm |
| Al | <0.5 | ppm |
| Na | <0.5 | ppm. |

4. An ultra dry, Cl-free, F doped fused silica glass article made by the process of claim 1.

5. The article of claim 4, wherein the concentration of ⁻OH is less than 1 ppm.

6. A method of forming an ultra dry, Cl-free, F doped fused silica glass which comprises the steps of:
providing a glass precursor in the from of a silica powder or soot preform; and
forming a dry suspension of said powder in a carrier gas to form a powder-soot stream and delivering said powder to a burner which melts said powder to form the glass, said powder-soot stream being exposed to a F-species via said burner.

7. The method of claim 6, wherein the ultra dry, Cl-free, F doped fused silica glass includes fluorine (F) in the range between 100 ppm-5 wt %.

8. The method of claim 6, wherein the ultra dry, Cl-free, F doped fused silica glass includes maximum threshold levels for the following key elements:

| | | |
|---|---|---|
| Cl | <5 | ppm |
| OH | <1 | ppm |
| Fe | <0.05 | ppm |
| Zr | <0.05 | ppm |
| Al | <0.5 | ppm |
| Na | <0.5 | ppm. |

9. An ultra dry, Cl-free, F doped fused silica glass article made by the process of claim 6.

10. The article of claim 9, wherein the concentration of ⁻OH is less than 1 ppm.

11. A method of forming an ultra dry, Cl-free, F doped fused silica glass which comprises the steps of:
providing a glass precursor in the form of a silica powder or soot preform having been made by flame hydrolysis or sol gel, using Cl-free precursors such as siloxanes; and
heating said powder in the bottom of a furnace, while exposing said powder to a F-species at a temperature and for a time sufficient to melt said powder and form a high purity fused silica glass in the bottom of said furnace.

12. The method of claim 11, wherein the ultra dry, Cl-free, F doped fused silica glass includes fluorine (F) in the range between 100 ppm-5 wt %.

13. The method of claim 11, wherein the ultra dry, Cl-free, F doped fused silica glass includes maximum threshold levels for the following key elements:

| | | |
|---|---|---|
| Cl | <5 | ppm |
| OH | <1 | ppm |
| Fe | <0.05 | ppm |
| Zr | <0.05 | ppm |
| Al | <0.5 | ppm |
| Na | <0.5 | ppm. |

14. An ultra dry, Cl-free, F doped fused silica glass article made by the process of claim 11.

15. The article of claim 14, wherein the concentration of ⁻OH is less than 1 ppm.

16. A method of forming an ultra dry, Cl-free, F doped fused silica glass which comprises the steps of:
providing a glass precursor in the form of a silica powder or soot preform having been made by flame hydrolysis or sol gel, using Cl-free precursors such as siloxanes; and
forming a dry suspension of said powder in a carrier gas to form a powder-soot stream and delivering said powder to a burner which melts said powder to form the glass, said powder-soot stream being exposed to a F-species via said burner.

17. The method of claim 16, wherein the ultra dry, Cl-free, F doped fused silica glass includes fluorine (F) in the range between 100 ppm-5 wt %.

18. The method of claim 16, wherein the ultra dry, Cl-free, F doped fused silica glass includes maximum threshold levels for the following key elements:

| | | |
|---|---|---|
| Cl | <5 | ppm |
| OH | <1 | ppm |
| Fe | <0.05 | ppm |
| Zr | <0.05 | ppm |
| Al | <0.5 | ppm |
| Na | <0.5 | ppm. |

19. An ultra dry, Cl-free, F doped fused silica glass article made by the process of claim 16.

20. The article of claim 19, wherein the concentration of ⁻OH is less than 1 ppm.
